(19) United States
(12) Patent Application Publication
(10) Pub. No.: US 2022/0153273 A1
(43) Pub. Date: May 19, 2022

(54) Detection of phase and timing of traffic signal lights and driver assistance method and systems

(71) Applicant: Emrah Metli, Antalya (TR)

(72) Inventor: Emrah Metli, Antalya (TR)

(21) Appl. No.: 17/045,182

(22) PCT Filed: Apr. 15, 2019
(86) PCT No.: PCT/TR2019/050245

§ 371 Date: Nov. 3, 2020

(30) Foreign Application Priority Data
May 7, 2018 (TR) 2018/06378

(51) Int. Cl. B60W 30/18; G08G 1/0967; G08G 1/01; G08G 1/056; G08G 1/09; B60W 60/00

(52) U.S. Cl. CPC B60W 30/18154; G08G 1/096783; G08G 1/0116; B60W 2556/50; G08G 1/094; B60W 60/001; B60W 2552/00; G08G 1/056

(57) ABSTRACT

The invention relates to a method and systems for detection of phase and timing of traffic signal lights and notifying drivers and controlling vehicle subsystems with driver assistance information generated through processing phase and timing information with location, speed and heading of vehicles. Phase and timing information is detected through analyzing data received from sensors installed on the traffic signal lights. Processing the detected traffic signal light phase and timing information with location, heading and speed information of vehicles, drivers can be notified to regulate the speed of vehicles according to the situation of the traffic signal lights. Additionally, providing the communication of adaptive cruise control, start-stop and autonomous driving systems of vehicles with the traffic signal lights, vehicles can be controlled by these systems according to the situation of the traffic signal lights.

### FIELD OF THE INVENTION

The present disclosure relates in general to a method and systems for detection of phase and timing of traffic signal lights and in particular to a method and systems for detection of traffic signal light's phase changing times, phase durations and signal cycle times to have knowledge of the traffic signal light's situation at any future time and assist drivers and control vehicle subsystems with this information.

### DESCRIPTION OF THE PRIOR ART

Traffic signal lights are used to regulate vehicle traffic at intersections. In general, three phases are used; red, yellow and green lights are activated at certain time intervals to control vehicle traffic at intersections. Traffic signal lights are operated in repetitive cycles with predetermined durations in three phases. Therefore, a cycle time is defined by the duration of all phases activated sequentially. The operation of traffic signal lights is fulfilled via traffic signal controllers (intersection control devices) installed at intersections. For the fixed time controllers, signal plans are decided according to the needs of every individual intersection by choosing preprogrammed timing plans. In practice, phase and cycle timing of any individual traffic signal may be varied according to time of the day or day of the week. For example, phase and cycle timing may be different for weekdays and weekends or rush hours in a day when heavy traffic usually occurs. Apart from the fixed time traffic signal controllers, adaptive traffic signal controllers regulate signal phase timings according to vehicle density with the information obtained from sensors such as magnetic loop detectors or camera etc. installed on or above the roads.

Traffic signal lights ensure safe passage of vehicles regulating vehicle movement at intersections but they cause increased fuel consumption, high exhaust emissions and waste of time. All of these problems stem from not knowing the current and future operational status of traffic signals. If the real time operational status and future signal timing plans of traffic signals could be known, this information would be transferred to vehicles moving on the roads to enable drivers or vehicle subsystems to control the vehicle according to the operational status of the traffic signal ahead so that achieving lower fuel consumption, lower exhaust emissions, reduced traffic jams and collisions resulting from red light violation can be avoided.

There are methods known in the art which aims to make traffic signal lights real time phase and timing information available. Phase and timings of traffic signals can be known connecting traffic signal controllers at individual intersections to a computer system at a traffic management center via fiber optic cables.

There are also known works in progress of intelligent traffic signal systems which transfer the operational status of traffic signals to vehicles. Ongoing works of The United States Department of Transportation's (USDOT) Cooperative Intersection Collision Avoidance Systems (CICAS) intelligent transportation systems research program aims to make drivers aware of the activities around an intersection which a vehicle is approaching using vehicle and infrastructure-based technologies. A technology called Dedicated Short-Range Communications (DSRC) is utilized for the wireless communication between vehicles and infrastructure.

U.S. Pat. No. 8,559,673 discloses that a map of traffic signals can be formed and used to detect real time operational status of traffic signals. The method includes identification of red and yellow objects within an image by associating geographic location and orientation of images of traffic signals by a computer and storing the three-dimensional locations of the traffic signal in memory. It also indicated that the maps may then be used to assist robotic vehicles or human drivers to identify the location and status of a traffic signal and instructions may be given to drivers based on the status of traffic signals.

U.S. Pat. No. 9,589,463 discloses a method of obtaining data relating to the timing of a transition between phases of a traffic control signal is described. The method involves obtaining live probe data relating to the travel of vehicles in the region of the traffic control signal and using the data to determine times at which a given transition of the signal has occurred. This is carried out by consideration of the distance from the traffic signal at which a vehicle waits when stopped at the signal and a time of passing the signal as determined using the probe data. Different transition time pairs are analyzed to obtain time differences between the transition times. A cycle time which best fits the time difference data is determined and used with the transition time data to predict future transition times of the traffic control signal. It is also specified that with the determined signal transition time data a speed advisory can be given to a driver or an adaptive cruise control system.

All of these methods and systems have certain limitations which can be solved by the desired characteristics of the present invention. Connecting traffic signal controllers to a traffic management center via cables requires costly infrastructure investment. The systems offering wireless communications like CICAS designed mainly for collision avoidance contain implementation problems because of the need of modernization of traffic signal controllers, high cost roadside units peculiar to the system and short-range wireless communications. The systems utilizing image processing are not efficient because of the deteriorated functionality of video camera technology in unsuitable outdoor environments and rainy or snowy weather. The methods using the movement of vehicles perform poorly on real-time data acquisition because they are based on predictions and require a lot of computing power.

Adaptive cruise control and autonomous driving systems are developed which perceive the environment and the road around a vehicle utilizing various sensors and image processing techniques. Another feature in vehicles called start-stop system is developed to save fuel shutting down the engine when vehicle movement stops. Yet these vehicle subsystems cannot communicate with traffic signal lights.

While it is possible to acquire the phase and timing of traffic control signals with various systems and methods, no system or method comprises the characteristic features of the invention disclosed here. Therefore, it is required to develop a technique which does not require costly infrastructure, utilizes commonly used wireless communication technologies, does not require modernization of present traffic signal controllers, does not affected by environmental conditions or weather and provide real-time information not require to make predictions. So, it is required to make an improvement in the technical field because of the aforementioned drawbacks and insufficiency of the related art.

### SUMMARY OF THE INVENTION

The invention is originated from the current state of the art and aims to solve the aforementioned drawbacks. Aspects and advantages of the invention will be set forth in part in the following description or may be learned through practice of the invention.

One aspect of the invention provides a method of detection of phase and timing of traffic signal lights to generate driver assistance information. The method includes receiving data from one or more sensors installed in a way to get a varied value when any of the phases of a traffic signal light is activated. Received sensor data are recorded and variations against time are monitored. Moments of change of the values of the sensor data which is monitored against time are determined and designated as phase change moments. The time periods between determined moments of change of the values of the sensor data are calculated to determine phase durations.

As mentioned here, various features can be used in various combinations for any embodiment. In an exemplary embodiment of the present invention, sensor installation can be made to monitor only one phase or every individual phases of the traffic signal light separately.

In another exemplary embodiment of the present invention, installation of sensors can be made integrated to the traffic signal light circuitry or separate from the traffic signal light circuitry depending on the type of the sensor.

In an exemplary embodiment of the present invention, sensor data can be collected and processed in a remote server. Alternatively, sensor data can be collected and processed in a data processing and broadcasting device situated at the intersection near the traffic signal lights.

In another exemplary embodiment of the present invention, location (i.e. latitude and longitude) and orientation (i.e. geographical positioning) information of the intersection where sensor data are received and speed limit information of the connecting roads to the intersection are designated in the server or data processing and broadcasting device.

In an exemplary embodiment of the present invention, driver assistance information can be generated through transmitting traffic signal phase and timing information of the intersection that a vehicle is approaching which is determined according to the location and heading information of the vehicle, with the location and orientation information and speed limit information of the intersection where traffic signal lights are located to an on-board device in the vehicle and processing with the location, heading and speed information of the vehicle.

In another exemplary embodiment of the present invention, driver assistance information can be generated through transmitting at least one of a location, heading and speed information of the vehicle to a remote server or data processing and broadcasting device situated at the intersection and processing with the traffic signal phase and timing information and location and orientation information of the intersection where traffic signal lights are located and then transmitting the driver assistance information to the on-board device in the vehicle.

In a detail of the present invention, driver assistance information may be the phase and timing information of the related traffic signal of the intersection that a vehicle is approaching. Alternatively, driver assistance information may be the speed information which a vehicle must be driven to pass the intersection that the vehicle is approaching when related traffic signal is at a green phase.

In another detail of the present invention, when determining the speed information which a vehicle must be driven to pass the intersection that a vehicle is approaching when related traffic signal is at a green phase, the speed limit on the road the vehicle is travelling is taken into account.

In an exemplary embodiment of the present invention, determined driver assistance information may be notified to the driver visually and/or audibly.

In another exemplary embodiment of the present invention, using the determined driver assistance information, at least one control input for an adaptive cruise control system of a vehicle can be generated to get the speed of the vehicle regulated according to the phase and timing information of the traffic signal lights.

In another exemplary embodiment of the present invention, using the determined driver assistance information, at least one control input for a start-stop system of a vehicle can be generated to get the engine of the vehicle regulated according to the phase and timing information of the traffic signals lights.

In another exemplary embodiment of the present invention, using the determined driver assistance information, at least one control input for an autonomous driving system of a vehicle can be generated to get the vehicle regulated according to the phase and timing information of the traffic signal lights.

Another aspect of the invention provides a system of detection of phase and timing of traffic signal lights to generate driver assistance information. The system includes at least one sensor installed in a way to get a varied value when any of the phases of a traffic signal light is activated, comprising wireless communication technologies, broadcasting acquired data wirelessly; a gateway receiving the sensor data and transmitting to a central server; a central server comprising processor and memory, recording and monitoring the variations of the received sensor data against time, determining moments of change of the sensor data values, calculating the time periods between moments of change of the sensor data values with the software and algorithm it possesses; an on-board device associated with the vehicle and in communication with the central server comprising wireless communication technologies, screen, speaker, processor and memory; a GPS module associated with the on-board device determining location, heading and speed of the vehicle.

As mentioned here, various features can be used in various combinations for any embodiment. In an exemplary embodiment of the present invention, sensor can be a light sensor.

In another exemplary embodiment of the present invention, sensor can be a color sensor.

In another exemplary embodiment of the present invention, sensor can be a voltage sensor.

In another exemplary embodiment of the present invention, sensor can be a current sensor.

In another exemplary embodiment of the present invention, on-board device can act as a gateway with its possession of wireless communication technologies and software application configured to transmit the received sensor data to a central server.

In another exemplary embodiment of the present invention, on-board device can be an electronic device like a smartphone comprising wireless communication technologies, GPS module, processor, memory, screen, speaker and software application configured to communicate with the central server, transmitting the location and heading information of the vehicle and receiving the traffic signal phase and timing information, location and orientation information of the intersection and speed limit information and configured to make necessary calculations to generate driver assistance information. Alternatively, on-board device can be an electronic device like a smartphone comprising wireless communication technologies, GPS module, processor, memory, screen, speaker and software application configured to communicate with the central server transmitting location, heading and speed information of the vehicle and receiving driver assistance information from the central server.

In another exemplary embodiment of the present invention, on-board device can be coupled to an adaptive cruise control system which regulates the speed of the vehicle with the determined driver assistance information according to the phase and timing information of the traffic signal lights.

In another exemplary embodiment of the present invention, on-board device can be coupled to a start-stop system which regulates the engine of the vehicle with the determined driver assistance information according to the phase and timing information of the traffic signal lights.

In another exemplary embodiment of the present invention, on-board device can be coupled to an autonomous driving system which regulates the vehicle with the determined driver assistance information according to the phase and timing information of the traffic signal lights.

Another aspect of the invention provides a system of detection of phase and timing of traffic signal lights to generate driver assistance information. The system includes at least one sensor installed in a way to get a varied value when any of the phases of a traffic signal light is activated, comprising wireless communication technologies, broadcasting acquired data wirelessly; a data processing and broadcasting device comprising wireless communication technologies, processor and memory, receiving the sensor data, recording and monitoring the variations of the received sensor data against time, determining moments of change of the sensor data values, calculating the time periods between moments of change of the sensor data values with the software and algorithm it possesses and broadcasting the determined traffic signal light information with the location and orientation information and speed limit information of the intersection where traffic signals are located; an on-board device associated with the vehicle and in communication with the data processing and broadcasting device comprising wireless communication technologies, screen, speaker, processor and memory; a GPS module associated with the on-board device determining location, heading and speed of the vehicle.

As mentioned here, various features can be used in various combinations for any embodiment. In an exemplary embodiment of the present invention, sensor can be a light sensor.

In another exemplary embodiment of the present invention, sensor can be a color sensor.

In another exemplary embodiment of the present invention, sensor can be a voltage sensor.

In another exemplary embodiment of the present invention, sensor can be a current sensor.

In another exemplary embodiment of the present invention, on-board device can be an electronic device like a smartphone comprising wireless communication technologies, GPS module, processor, memory, screen, speaker and software application configured to communicate with the data processing and broadcasting device, transmitting the location and heading information of the vehicle and receiving the traffic signal phase and timing information, location and orientation information of the intersection and speed limit information and configured to make necessary calculations to generate driver assistance information. Alternatively, on-board device can be an electronic device like a smartphone comprising wireless communication technologies, GPS module, processor, memory, screen, speaker and software application configured to communicate with the data processing and broadcasting device transmitting location, heading and speed information of the vehicle and receiving driver assistance information from the data processing and broadcasting device.

In another exemplary embodiment of the present invention, on-board device can be coupled to an adaptive cruise control system which regulates the speed of the vehicle with the determined driver assistance information according to the phase and timing information of the traffic signal lights.

In another exemplary embodiment of the present invention, on-board device can be coupled to a start-stop system which regulates the engine of the vehicle with the determined driver assistance information according to the phase and timing information of the traffic signal lights.

In another exemplary embodiment of the present invention, on-board device can be coupled to an autonomous driving system which regulates the vehicle with the determined driver assistance information according to the phase and timing information of the traffic signal lights.

Structural and characteristic features and all advantages of the present invention will be better understood with reference to the figures and detailed explanations and must be evaluated in light of these detailed explanations with reference to the figures.

### BRIEF DESCRIPTION OF THE DRAWINGS

FIG. 1, illustrates an exemplary embodiment of the present invention of a system and method of detection of traffic signal light phase and timing.

FIG. 2, illustrates an exemplary embodiment of the present invention of a method and system of generation of driving assistance information.

### EXPLANATION OF REFERENCED PARTS

110. Traffic signal light-1

120. Sensor

130. Sensor data-1

140. Data processing and broadcasting device-1

150. Gateway

160. Internet connection

170. Central server-1

180. Graph showing sensor data recorded and monitored against time

190. Pattern

210. Vehicle

220. Traffic signal light-2

230. Central server-2

240. Data processing and broadcasting device-2

250. Compass degrees

260. Communication between on-board device and central server

270. Communication between on-board device and data processing and broadcasting device

### DESCRIPTION OF THE PREFERRED EMBODIMENTS

In this detailed description, a few exemplary embodiments of the invention are explained via figures solely for the purposes of better understanding of the subject and not limitations of the invention to these examples. Each example is provided by way of explanation of the invention, not limitation of the invention. In fact, it will be apparent to those skilled in the art that various modifications and variations can be made in the present invention without departing from the scope or spirit of the invention.

The technology discussed herein makes reference to servers, gateways, software applications and other computer-based and electronic systems as well as actions taken and information sent to and from such systems. One of ordinary skill in the art will recognize that the inherent flexibility of computer-based systems allows for a great variety of possible configurations of components. For example, server processes discussed herein may be implemented using a single server or multiple servers working in combination. Applications may be implemented on a single system or distributed across multiple systems. Distributed components may operate sequentially or in parallel.

The present disclosure also makes reference to the relay of communicated data over one or more communications networks. It should be appreciated that network communications can comprise sending and/or receiving information over one or more networks of various forms. For example, a network can comprise a local area network (LAN), wide area network (WAN), the Internet, cellular networks or other type(s) of networks. A network may comprise any number and/or combination of hard-wired, wireless or other communication links.

As used herein, the term orientation of intersections where traffic signal lights present is intended to refer to geographical positioning of intersections. The term geographical positioning is intended to refer to the direction of every roadway such as north, south, east, west or any other direction in between of those coming together at an intersection which can be defined as the point of crossing of two or more roadways.

As used herein, the term GPS is intended to refer to all global navigation satellite systems that have different names in different countries.

As used herein, the term location of vehicles is intended to refer to coordinates comprising latitude and longitude values determined by GPS and the term heading is intended to refer to the directions formed by the changing coordinates of the vehicles in time, determined by GPS, resulting from the movements of the vehicles.

As used herein, the term phase of traffic signal lights is intended to refer to any component of these lights in red, yellow and green colors. The term phase changing times is intended to refer to the moment of activation of any of these phases. The term phase duration is intended to refer to time intervals in which any of the phases stays activated. The term signal cycle time is intended to refer to the duration in which sequentially activating phases of traffic signal lights complete a circulation.

Generally, the present disclosure is directed to systems and method of providing detection of phase and timing of traffic signal lights and notifying drivers and controlling vehicle subsystems with driver assistance information which is acquired by processing detected phase and timing information of traffic signal lights with location, speed and heading information of vehicles. In an exemplary embodiment of the present invention, data are received from one or more sensors which are installed in a way to get varied values when any of the phases of a traffic signal light is activated. Sensor installation can be made to monitor only one phase or every individual phases of the traffic signal light separately. Also, installation of sensors can be made integrated to the traffic signal light circuitry or separate from the traffic signal light circuitry depending on the type of the sensor. For example, a light sensor or a color sensor is installed at a position to sense the light intensity of a traffic signal light separate from the traffic signal light circuitry. As another implementation, a voltage sensor or a current sensor is installed integrated to the traffic signal light circuitry to monitor variations of voltage or current values at the circuit in which the sensor is installed.

In an exemplary embodiment of the present invention, sensor data via a gateway can be collected and processed in a remote server. Alternatively, sensor data can be collected and processed in a data processing and broadcasting device situated at the intersection near the traffic signal lights. Processing of sensor data comprises recording and monitoring the variations of received sensor data against time. Moments of change of the values of the sensor data which is monitored against time are determined and designated as phase change moments. Cycle time information of the traffic signal is obtained by designating a signal phase to every duration of calculated time period between determined moments of change of the values of the sensor data. With this information, it is possible to get the knowledge of the phase and the remaining time to phase change of the traffic signal at any future time. All this determined information is compared with received sensor data continuously and revised in case of any disparity. Additionally, location and orientation information of the intersection where sensor data are received and speed limit information of the connecting roads to the intersection are specified in the server or data processing and broadcasting device.

In an exemplary embodiment of the present invention, driver assistance information can be generated through transmitting traffic signal phase and timing information of the intersection that a vehicle is approaching which is determined according to the location and heading information of the vehicle, with the location and orientation information and speed limit information of the intersection where traffic signal lights are located to an on-board device in the vehicle and processing with the location, heading and speed information of the vehicle. According to this exemplary embodiment, on-board device can be an electronic device like a smartphone comprising wireless communication technologies, GPS module, processor, memory, screen, speaker and software application configured to communicate with the central server or data processing and broadcasting device, transmitting the location and heading information of the vehicle and receiving the traffic signal phase and timing information, location and orientation information of the intersection and speed limit information and configured to make necessary calculations to generate driver assistance information. Alternatively, driver assistance information can be generated through transmitting at least one of a location, heading and speed information of the vehicle to a remote server or data processing and broadcasting device situated at the intersection and processing with the traffic signal phase and timing information and location and orientation information of the intersection where traffic signal lights are located and then transmitting the driver assistance information to the on-board device in the vehicle. According to this exemplary embodiment, on-board device can be an electronic device like a smartphone comprising wireless communication technologies, GPS module, processor, memory, screen, speaker and software application configured to communicate with the remote server or data processing and broadcasting device transmitting location, heading and speed information of the vehicle and receiving driver assistance information from the remote server or data processing and broadcasting device.

In a detail of the present invention, driver assistance information may be the phase and timing information of the related traffic signal of the intersection that a vehicle is approaching. This information includes notification of the driver visually and/or audibly about the phase and remaining time to phase change of the related traffic signal of the intersection that the vehicle is approaching which is determined according to the location and heading of the vehicle including the approach direction of the vehicle to the intersection. Alternatively, driver assistance information may be the speed information which a vehicle must be driven to pass the intersection that the vehicle is approaching when related traffic signal is at a green phase. This information includes notification of the driver visually and/or audibly about the speed information to pass the intersection when related traffic signal is at a green phase which is calculated according to the location, heading and speed of the vehicle including the approach direction to the intersection and the distance to the intersection. This information is revised continuously according to the location of the vehicle. The speed limit on the road the vehicle is traveling is taken into account when determining the speed information.

In an exemplary embodiment of the present invention, on-board device can be coupled to an adaptive cruise control system of a vehicle and using the determined driver assistance information, at least one control input can be generated to get the speed of the vehicle regulated according to the phase and timing information of the traffic signals. Thus, adaptive cruise control system can automatically regulate the speed of the vehicle to pass the intersection that the vehicle is approaching when the related traffic signal is at a green phase.

In an exemplary embodiment of the present invention, on-board device can be coupled to a start-stop system of a vehicle and using the determined driver assistance information, at least one control input can be generated to get the engine of the vehicle regulated according to the phase and timing information of the traffic signals. Thus, start-stop system recognizing that the vehicle stopped because of a traffic signal can make decisions to stop or not to stop the engine of the vehicle according to the phase and the remaining time to phase change. For example, in case the vehicle has stopped at a red light, the system can decide to stop or not to stop the engine according to the remaining time to green light or system can be adapted not to stop the engine in case the vehicle has stopped at green light for whatsoever reason. Additionally, the system can be adapted not to stop the engine in cases when the vehicle has stopped not because of traffic signals.

In an exemplary embodiment of the present invention, on-board device can be coupled to an autonomous driving system of a vehicle and using the determined driving assistance information, at least one control input can be generated to get the vehicle regulated according to the phase and timing information of the traffic signals. Thus, communicating with the traffic signal lights, autonomous driving system can regulate the vehicle according to the phase and timing information of the traffic signal light that the vehicle is approaching.

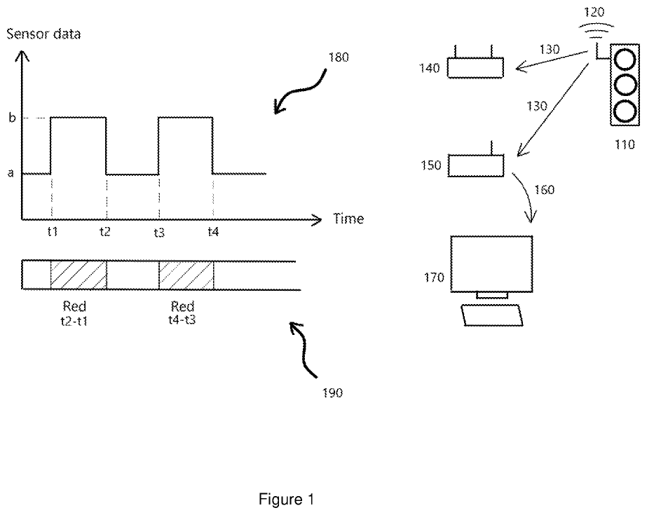

FIG. 1 illustrates an exemplary traffic signal light phase and timing detection system and method according to an exemplary embodiment of the present disclosure. In the system of detection of traffic signal light phase and timing information of FIG. 1, sensor data (130) received from a sensor (120) installed on red phase of a traffic signal light (110) are transmitted wirelessly to a data processing and broadcasting device (140). In an alternative exemplary embodiment of the present disclosure, sensor data (130) received from a sensor (120) installed on red phase of a traffic signal light (110) are transmitted via a gateway (150) through Internet connection (160) to a central server (170). Sensor data (130) can be transmitted to data processing and broadcasting device (140) or gateway (150) via

Bluetooth, WiFi, cellular networks or other radio frequency communication networks or protocols or visible light communication technologies like LiFi or infrared communication technologies like UV.

In the method of detection of traffic signal light phase and timing information of FIG. 1, the graph (180) which is formed by varying sensor data received continuously by data processing and broadcasting device (140) or central server (170) and recorded and monitored against time with the software and algorithm they possess is illustrated. At this graph (180), in which sensor data variations are recorded and monitored, “y” axis shows the sensor data (130) values and “x” axis shows the time. In this implementation of an exemplary embodiment, sensor data (130) received from a sensor (120) installed on the red phase is shown as value “a” on the graph (180) when the red phase is not activated. Sensor data (130) value at time “t1” when the red phase is activated is shown as “b” on the graph (180). Change in sensor data (130) value at time “t2” when the red phase is deactivated is shown as “a”. The moments of varying values of sensor data (130) which is continuously received are shown as “t3”, “t4” . . . at the continuation of the graph (180). A pattern (190) is formed via calculating the durations between moments of change of the sensor data (130) determined on the graph (180). At this pattern (190), the moments of sensor data (130) variations are adopted as phase change moments and a related signal phase is appointed for every distinct duration. For example, the duration “t2-t1”, which is the duration of sensor data (130) value “b” of activated red signal phase, is calculated to determine the duration while the red signal phase stays activated. The duration 1342″, which is the duration of sensor data (130) value “a” of deactivated red signal phase, is calculated to determine the duration while the yellow and green signal phases stay activated. With this determined information, it is possible to get the knowledge of phase and remaining time to phase chance of a traffic signal light (110) at any future time. All this determined information is compared with received sensor data (130) continuously and the pattern (190) is revised according to new situation in case of any disparity.

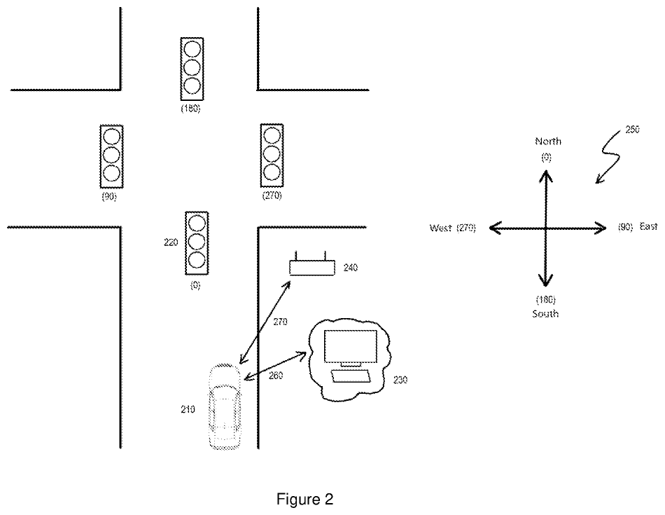

FIG. 2 illustrates an exemplary embodiment of method and system of generating driver assistance information. According to the method and system of generating driver assistance information of FIG. 2, the intersection and related traffic signal light (220) that a vehicle (210) is approaching is determined, detecting and tracking the location and heading of the vehicle (210) via a GPS device (not shown) associated with the on-board device (not shown). The location and orientation information of the intersections are designated in the central server (230) or data processing and broadcasting device (240) to determine the intersection and the related traffic signal light (220) that the vehicle (210) will encounter. The orientation of the intersection and the heading of the vehicle (210) are determined according to compass grades (250). Thus, the orientation of the intersection illustrated in FIG. 2 is designated as “0”, “90”, “180” and “270”. The traffic signal lights at this intersection is designated according to the direction of the connecting roadways. For example, the traffic signal light (220) controlling the south-north oriented roadway is designated as “0” degrees. In the same way, the heading of the vehicle (210) illustrated in the exemplary embodiment of FIG. 2 traveling toward the north direction and tracked continuously via the GPS is designated as “0” and associated with the traffic signal light (220) designated as “0” degrees. The phase and timing information of the traffic signal light (220) associated with the vehicle (210) according to the traveling direction is transmitted (260, 270) to the on-board device in communication with the central server (230) or data processing and broadcasting device (240). The onboard device generates driving assistance information according to the location, heading and speed information of the vehicle (210) and phase and timing information of the traffic signal light (220). The driver assistance information can be the phase and timing information of the traffic signal light (220) and the speed information that the vehicle (210) must be driven to pass the intersection when the traffic signal light (220) is at a green phase. Alternatively, driver assistance information can be generated through transmitting (260, 270) at least one of a location, heading and speed information of the vehicle (210) to a remote server (230) or data processing and broadcasting device (240) and processing with the traffic signal phase and timing information and location and orientation information of the intersection where traffic signal light (220) is located and then transmitting (260, 270) the driver assistance information to the on-board device in the vehicle (210). The communication (260) between the on-board device and the central server (230) can be implemented through the Internet. The communication (270) between the on-board device and data processing and broadcasting device (240) can be implemented through Bluetooth, Wi-Fi, cellular networks, DSRC or other radio frequency communication networks or protocols or visible light communication technologies like Li-Fi or infrared communication technologies like UV.

1. A method for detection of phase and timing of traffic signal lights to generate driver assistance information through processing with location, heading and speed of vehicles, the method comprising:
receiving data from one or more sensors installed in a way to get a varied value when any of the phases of a traffic signal light is activated,
recording and monitoring of received sensor data variations against time,
determining moments of change of the values of the sensor data which is monitored against time and designating as phase change moments,
calculating the time periods between determined moments of change of the values of the sensor data to determine phase durations

2. The method of claim 1, wherein sensor installation is made to monitor only one phase or every individual phases of the traffic signal light separately.

3. The method of claim 1, wherein installation of sensors is made integrated to the traffic signal light circuitry or separate from the traffic signal light circuitry depending on the type of the sensor.

4. The method of claim 1, wherein sensor data is collected and processed in a remote server or in a data processing and broadcasting device situated at the intersection near the traffic signal lights.

5. The method of claim 1, wherein location (i.e. latitude and longitude) and orientation (i.e. geographical positioning) information of the intersection where sensor data are received and speed limit information of the connecting roads to the intersection are designated in the server or data processing and broadcasting device.

6. The method of claim 1, wherein driver assistance information is generated through transmitting traffic signal phase and timing information of the intersection that a vehicle is approaching which is determined according to the location and heading information of the vehicle, with the location and orientation information and speed limit information of the intersection where traffic signal lights are located to an on-board device in the vehicle and processing with the location, heading and speed information of the vehicle.

7. The method of claim 1, wherein driver assistance information is generated through transmitting at least one of a location, heading and speed information of the vehicle to a remote server or data processing and broadcasting device situated at the intersection and processing with the traffic signal phase and timing information and location and orientation information of the intersection where traffic signal lights are located and then transmitting the driver assistance information to the on-board device in the vehicle.

8. The method of claim 1, wherein driver assistance information is the phase and timing information of the related traffic signal of the intersection that a vehicle is approaching and/or the speed information which a vehicle must be driven to pass the intersection that the vehicle is approaching when related traffic signal is at a green phase.

9. The method of claim 8, wherein when determining the speed information which a vehicle must be driven to pass the intersection that a vehicle is approaching when related traffic signal is at a green phase, the speed limit on the road the vehicle is travelling is taken into account.

10. The method of claim 1, wherein determined driver assistance information is notified to the driver visually and/or audibly.

11. The method of claim 1, wherein using the determined driver assistance information, at least one control input for an adaptive cruise control system of a vehicle is generated to get the speed of the vehicle regulated according to the phase and timing information of the traffic signal lights.

12. The method of claim 1, wherein using the determined driver assistance information, at least one control input for a start-stop system of a vehicle is generated to get the engine of the vehicle regulated according to the phase and timing information of the traffic signals lights.

13. The method of claim 1, wherein using the determined driver assistance information, at least one control input for an autonomous driving system of a vehicle is generated to get the vehicle regulated according to the phase and timing information of the traffic signal lights.

14. A system for detection of phase and timing of traffic signal lights to generate driver assistance information through processing with location, heading and speed of vehicles, the system comprising:
at least one sensor installed in a way to get a varied value when any of the phases of a traffic signal light is activated, comprising wireless communication technologies, broadcasting acquired data wirelessly,
a gateway comprising wireless communication technologies, receiving the sensor data and transmitting to a central server,
a central server comprising processor and memory, recording and monitoring the variations of the received sensor data against time, determining moments of change of the sensor data values, calculating the time periods between moments of change of the sensor data values with the software and algorithm it possesses,
an on-board device associated with the vehicle and in communication with the central server comprising wireless communication technologies, screen, speaker, processor and memory,
a GPS module associated with the on-board device determining location, heading and speed of the vehicle.

15. The system of claim 14, wherein sensor is a light sensor.

16. The system of claim 14, wherein sensor is a color sensor.

17. The system of claim 14, wherein sensor is a voltage sensor.

18. The system of claim 14, wherein sensor is a current sensor.

19. The system of claim 14, wherein on-board device acts as a gateway with its possession of wireless communication technologies and software application configured to transmit the received sensor data to a central server.

20. The system of claim 14, wherein on-board device is an electronic device like a smartphone comprising wireless communication technologies, GPS module, processor, memory, screen, speaker and software application configured to communicate with the central server, transmitting the location and heading information of the vehicle and receiving the traffic signal phase and timing information, location and orientation information of the intersection and speed limit information and configured to make necessary calculations to generate driver assistance information.

21. The system of claim 14, wherein on-board device is an electronic device like a smartphone comprising wireless communication technologies, GPS module, processor, memory, screen, speaker and software application configured to communicate with the central server transmitting at least one of a location, heading and speed information of the vehicle and receiving driver assistance information from the central server.

22. The system of claim 14, wherein on-board device is coupled to an adaptive cruise control system which regulates the speed of the vehicle with the determined driver assistance information according to the phase and timing information of the traffic signal lights.

23. The system of claim 14, wherein on-board device is coupled to a start-stop system which regulates the engine of the vehicle with the determined driver assistance information according to the phase and timing information of the traffic signal lights.

24. The system of claim 14, wherein on-board device is coupled to an autonomous driving system which regulates the vehicle with the determined driver assistance information according to the phase and timing information of the traffic signal lights.

25. A system for detection of phase and timing of traffic signal lights to generate driver assistance information through processing with location, heading and speed of vehicles, the system comprising:
at least one sensor installed in a way to get a varied value when any of the phases of a traffic signal light is activated, comprising wireless communication technologies, broadcasting acquired data wirelessly,
a data processing and broadcasting device comprising wireless communication technologies, processor and memory, receiving the sensor data, recording and monitoring the variations of the received sensor data against time, determining moments of change of the sensor data values, calculating the time periods between moments of change of the sensor data values with the software and algorithm it possesses and broadcasting the determined traffic signal light information with the location and orientation information and speed limit information of the intersection where traffic signals are located,
an on-board device associated with the vehicle and in communication with the data processing and broadcasting device comprising wireless communication technologies, screen, speaker, processor and memory,
a GPS module associated with the on-board device determining location, heading and speed of the vehicle.

26. The system of claim 25, wherein sensor is a light sensor.

27. The system of claim 25, wherein sensor is a color sensor.

28. The system of claim 25, wherein sensor is a voltage sensor.

29. The system of claim 25, wherein sensor is a current sensor.

30. The system of claim 25, wherein on-board device is an electronic device like a smartphone comprising wireless communication technologies, GPS module, processor, memory, screen, speaker and software application configured to communicate with the data processing and broadcasting device, transmitting the location and heading information of the vehicle and receiving the traffic signal phase and timing information, location and orientation information of the intersection and speed limit information and configured to make necessary calculations to generate driver assistance information.

31. The system of claim 25, wherein on-board device is an electronic device like a smartphone comprising wireless communication technologies, GPS module, processor, memory, screen, speaker and software application configured to communicate with the data processing and broadcasting device transmitting location, heading and speed information of the vehicle and receiving driver assistance information from the data processing and broadcasting device.

32. The system of claim 25, wherein on-board device is coupled to an adaptive cruise control system which regulates the speed of the vehicle with the determined driver assistance information according to the phase and timing information of the traffic signal lights.

33. The system of claim 25, wherein on-board device is coupled to a start-stop system which regulates the engine of the vehicle with the determined driver assistance information according to the phase and timing information of the traffic signal lights.

34. The system of claim 25, wherein on-board device is coupled to an autonomous driving system which regulates the vehicle with the determined driver assistance information according to the phase and timing information of the traffic signal lights.
